(19) United States
(12) Patent Application Publication
(10) Pub. No.: US 2017/0300129 A1
(43) Pub. Date: Oct. 19, 2017

(54) KEYPRESS PROCESSING METHOD AND APPARATUS FOR TERMINAL

(71) Applicants: HISENSE ELECTRIC CO., LTD., Qingdao (CN); HISENSE USA CORPORATION, Suwanee, GA (US); HISENSE INTERNATIONAL CO., LTD., Qingdao (CN)

(72) Inventor: YUTAI LU, QINGDAO (CN)

(21) Appl. No.: 15/394,680

(22) Filed: Dec. 29, 2016

(30) Foreign Application Priority Data
Apr. 19, 2016 (CN) 201610240859.9

(51) Int. Cl. G06F 3/023; H04N 21/4782; H04N 21/422; H04N 21/81; G06F 3/0489

(52) U.S. Cl. CPC G06F 3/0238; H04N 21/8173; G06F 3/0489; H04N 21/42212; H04N 21/4782

(57) ABSTRACT

A keypress processing method for a terminal and a keypress processing apparatus for a terminal are provided. The keypress processing method for a terminal includes: receiving a keypress processing request carrying a keypress value; determining a target application matching with the keypress value according to keypress value information reported by an application in running state in the terminal, wherein the application comprises a network Web application or a local application, and the keypress value information comprises a set of keypress values supported by the application; and sending the keypress processing request to the target application for processing. The present application provides high efficiency in processing keypress processing request, and prevents the keypress from being lost.

### CROSS-REFERENCE TO RELATED APPLICATIONS

the present application claims priority to Chinese patent application No. 201610240859.9, filed on Apr. 19, 2016, entitled “Keypress Processing Method and Apparatus for Terminal”, the contents of which are incorporated herein by reference in its entirety.

### TECHNICAL FIELD

The present application relates to the field of communication technology and, particularly, to a keypress processing method for a terminal and a keypress processing apparatus for a terminal.

### BACKGROUND

With the development of smart TVs and the rise of of HyperText Markup Language (HTML6), network (Web) applications are becoming a trend. Typically, various TV operating systems support two types of applications at the same time, namely local applications and Web applications. For instance, an Android system supports both local Android application package (Apk) file applications and Web applications.

Due to the increasing variety of applications, in a smart TV operating system, there are typically multiple application processes running A Smart TV generally uses an application Management (AM) to implement keypress distribution management of an application. The AM method can send the keypresses to an currently active application. That is, after receiving a keypress sent by an operating system, the AM will first select the currently active application among currently running multiple processes, to process the keypress. If the currently active application is a local application, the AM will hands the keypress to this local application for processing. If the current keypress is not included in a set of valid keypresses of the current local application, it will typically be passed, according to priorities of the running processes, to the next application, such as a browser, for processing.

### SUMMARY

The present application provides a keypress processing method for a terminal and a keypress processing apparatus for a terminal.

In a first aspect, the present application provides a keypress processing method for a terminal, including:

receiving a keypress processing request carrying a keypress value;

determining a target application matching with the keypress value according to keypress value information reported by an application in running state in the terminal, wherein the application includes a network Web application or a local application, and the keypress value information includes a set of keypress values supported by the application; and

sending the keypress processing request to the target application for processing.

In a second aspect, the present application provides a keypress processing apparatus for a terminal, including: a memory for storing instructions; a processor coupled with the memory and configured to execute the instructions stored in the memory, wherein the processor is further configured to:

receive a keypress processing request carrying a keypress value;

determine a target application matching with the keypress value according to keypress value information reported by an application in running state in the terminal, wherein the application includes a network Web application or a local application, and the keypress value information include a set of keypress values supported by the application; and

send the keypress processing request to the target application for processing.

### BRIEF DESCRIPTION OF DRAWINGS

A brief description will be given hereinafter to the accompany drawings which will be used in the description of embodiments of the present application or related art in order to explain the technical solutions of embodiments of the present application or related art more clearly. Apparently, the drawings described below are merely illustrating some embodiments of the present application. Those skilled in the art may obtain other drawings according to these drawings without paying any creative labor.

FIG. 1 is a flowchart illustrating a keypress processing method for a terminal provided in some embodiments of the present application;

FIG. 2 is a schematic structural diagram of a keypress processing apparatus for a terminal provided in some embodiments of the present application; and

FIG. 3 is a schematic structural diagram of a terminal provided in some embodiments of the present application.

### DETAILED DESCRIPTION

In order to make the purposes, the technical solutions and the advantages of the present application more clear, the technical solutions of the present application will be described below clearly and completely with reference to the accompanying drawings. Obviously, the described embodiments are only part of the embodiments of the present application, rather than all of them. According to the embodiments of the present application, all other embodiments obtained by those skilled in the art without any creative work will fall within the protection scope of the present application.

In prior art, after receiving a keypress sent by an operating system, the AM will first select a currently active application among currently running multiple processes to process the keypress. If the currently active application is a local application, the AM will hands the keypress to the local application for processing. If the current keypress is not included in a set of valid keypresses of the current local application, it will typically be passed, according to priorities of the running processes, to the next application, such as a browser, for processing. For a Web application, its running carrier is usually a browser or a related web engine and the web application runs only in an instance of a browser in the AM, and the AM cannot recognize its specific running content, that is, the AM cannot recognize specific Web application running in a browser. Hence in keypress distribution management, if the currently active application is a Web application, the AM will directly send related keypress information to a browser in which the Web application is running, for processing, and then the browser may pass the keypress information to this currently active Web application. However, if the keypress information is irrelevant to this currently active Web application in the browser, the browser will not pass the keypress information to other Web applications running in the browser, or other local applications. For example, if two Web applications are running in a browser, respectively Web-A application and Web-B application, among which Web-A application is currently active application, then when the AM transfers a keypress value, which is assumed to be keyA, to the browser for processing, the browser is unaware of which Web application the user intend to control by sending this keyA, and at this time the browser will send the keyA to the currently active Web-A application. At this point, if the keyA is not in a set of valid keypresses that the Web-A application can process, the keyA will be discarded by the Web-A application, while the Web-B that really needs to process keyA cannot receive the keypress value.

The terminal related in this embodiment of the present application includes, but is not limited to, smart TV, smartphone, and other smart terminal devices. The following embodiments will be described by taking only smart TV as an example.

Applications running on a smart TV may be categorized into two types, namely local applications and Web applications. The local applications are developed using local languages, such as Java, C, C++, etc. The Web applications are developed using HTML5 related technologies, such as scripting languages, e.g. JavaScript. The Web applications are mainly characterized by running in Web environments. Existing Web running environments include three types: Web operating system, browser, and Web application supporting frameworks (e.g., Web engines), with common features of parsing HTML document, and parsing execution in conjunction with scripting languages.

Mainly in view of the following problem: a AM in lower layers of the Android system is unable to recognize Web applications (i.e. upper layer applications) running in a browser, and thus the AM in keypress distribution only can recognize a browser and a local application, and distribution and processing of the keypress cannot be achieved by a Web application, accordingly, embodiments of the present application provide a portable implementation method completely independent of TV platform, operating system and AM.

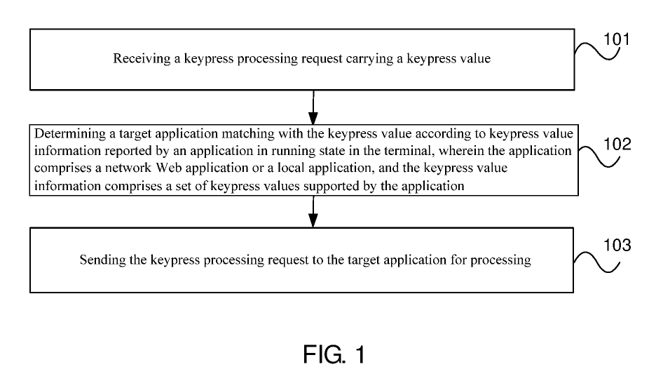

FIG. 1 is a flowchart illustrating a keypress processing method for a terminal provided in some embodiments of the present application. As depicted in FIG. 1, the method includes:

Step 101: receiving a keypress processing request carrying a keypress value;

Step 102: determining a target application matching with the keypress value according to keypress value information reported by an application in running state in the terminal, wherein the application includes a network Web application or a local application, and the keypress value information include a set of keypress values supported by the application; and

Step 103: sending the keypress processing request to the target application for processing.

Exemplarily, a terminal receives a keypress processing request carrying a keypress value, and determines, among currently running applications, an application matching with the keypress value according to keypress value information reported by an application in running state in the terminal. The keypress value information reported by an application in running state in the terminal may be one reported in advance to the terminal after the application is downloaded or before the application is launched, and may include a set of keypress values supported by the application, i.e., all keypress values valid for the application. The application in running state in the terminal may be a Web application or a local applications. If there is a target application matching with the keypress value, the keypress processing request will be sent to the target application for processing, so that the target application perform an operation corresponding to the keypress value. In prior art, the AM, when distributing a keypress, is unable to recognize Web applications running in a browser and only simply pass the keypress to the currently running browser and if a Web application that is in an active state in the browser is not relevant to the keypress, the keypress will be discarded by the active Web application, and other applications running in a background and relevant to the keypress, i.e. applications that the user really intends to control, are unable to perform the operation corresponding to the keypress. Compared with the above prior art, the method of embodiments of the present application can directly send the keypress to a Web application or a local application relevant to the keypress, without causing a loss of the keypress and having a high efficiency. Further, the method of embodiments of the present application can directly send the keypress to a Web application or a local application relevant to the keypress, without causing a loss of the keypress.

For example, a user launches a qq Web application in an operating system of a smart TV, and this Web application is in an active state. At this moment, if the user wants to realize a volume control function of the TV by the volume key of a remote control, then this operation behavior of the user will fail to alter the volume level of the TV because most of the existing volume bars are Web applications running based on browsers. That is, the TV does not process its volume level. This is because that the keypress value of the volume key received by the browser is directly handed over to the currently active Web qq application, but the Web qq application cannot recognize the keypress value of the volume key and directly discards the keypress value, and thereby the TV does not perform the volume operation.

For another example, two applications are running in the terminal, one of which is a Web application running in a browser, the other is an opened Word local application. When a user wants to type the keyboard to input a text to the word local application, if the Web application in the browser is currently active, then the keypress will be received by the browser and forwarded straightly to the Web application running in the browser. If the keypress cannot be recognized by the Web application, it will be directly discarded, and thereby the Word local application that is really waiting for this keypress will not be able to receive corresponding keypress information, and thus is unable to perform the operation what the user really wants.

If the method of embodiments of the present application is used in the above example, the keypress may be directly matched to corresponding target application matching with keypress value of the keypress. In this regard, if the target application is in an inactive state, it is possible to first activate the target application, and then send this keypress processing request to the target application for processing.

In this application, the terminal may be based entirely on Web technologies, performing functions of steps of the above method by constructing an application using HTML5, JavaScript, and the like. Such an application may be named “core user interface (UI) processing program. The application may run in a separate browser and is in a permanently active state. That is, the core UI processing program is a Web application and is configured to receive the keypress processing request sent by AM, determine a target application matching with the keypress value according to keypress value information reported by an application in running state in the terminal, and then send the keypress processing request to the target application for processing. In substance, the core UI processing program does not different from other Web applications. That is, when AM receives a keypress processing request, e.g. a keypress processing request generated by pressing a keypress on the remote control, it may send the keypress processing request to the core UI processing program, so that the terminal can receive the keypress processing request by the core UI processing program; search, by the core UI processing program, the target application matching with the keypress value according to keypress value information reported by an application in running state; and then send, by the core UI processing program, the keypress processing request to the target application for processing. In this case, the core UI processing program may internally store, or obtain by computation, keypress value information of all applications. That is, all applications in the terminal may be registered in the core UI processing program and report keypress value information thereto. In other words, before searching the target application matching with corresponding keypress value according to keypress value information reported by an application in running state, it is also possible to receive, by the core UI processing program, the keypress value information reported by an application in running state. If the core UI processing program is the target application matching with corresponding keypress value and is in an active state, the core UI processing program will directly process the key processing request. If the target application matching with the keypress value is other applications in an inactive state, it is possible to first activate the target application and then to send the keypress processing request to the target application for processing. The other target applications may be local applications or Web applications.

Construction of the above core UI processing program is implemented by Web-based technologies. In the present application, it is not limited to Web-based technologies, and it can also be implemented by other technologies, including Node.js (which is realized on server side and supports JavaScript), traditional languages, etc. An object of the present application is to provide a method independent of terminal platforms and AMs, and at this case, use of the Web-based technologies may achieve better portability.

In the method of the present application, it does not need to change the platform or the AM program, and additionally, it also does not need to make any change to a Web application or a local application and the core UI processing program has first level of priority for processing a keypress, and all logics are implemented in the core UI processing program wherein the logics are flexible and integral and have good portability.

According to the keypress processing method for a terminal provided in embodiments of the present application, a keypress processing request carrying a keypress value is first received, and then is distributed to a target application matching with the keypress value according to keypress value information reported by an application that is running in the terminal, wherein the application includes a network Web application or a local application, and the keypress value information includes a set of keypress values supported by the application. In prior art, the AM, when distributing a keypress, is unable to recognize a Web application running in a browser and only simply pass the keypress to the currently running browser and if a Web application that is in an active state in the browser is not relevant to the keypress, the keypress will be discarded by the active Web application, and other application running in a background and relevant to the keypress, i.e. application that the user really intends to control, is unable to perform the operation corresponding to the keypress. Compared with the above prior art, the method of embodiments of the present application can directly send the keypress to a Web application or a local application relevant to the keypress, without causing a loss of the keypress and having a high efficiency.

A method of implementation is provided in some embodiments of the present application, where, before Step 103, the following operations may also be performed:

activating a target application if the target application is running in a background.

Exemplarily, if the target application is running in a background, i.e. it is not an active application, it needs to activate the application before the keypress processing request is sent to the application for processing.

As a possible implementation, this activating process may be realized by sending a request for activating a certain application to the AM. Then, the keypress processing request may be sent. Of course, this activating process may be realized by sending the request for activating a certain application to other application having an activating function. There is no limit to this.

Some embodiments of the present application provide a method for determining the target application matching with the keypress value. That is, Step 102 may be implemented as follows:

determining at least one application matching with the keypress value according to keypress value information reported by an application in running state; and

identifying a currently active application among the at least one application as the target application.

Exemplarily, first, it needs to determine a target application matching with a keypress value according to keypress value information reported by an application that is in running state. Here, there may be multiple applications matching with the keypress value, and thus it needs to determine states of these applications to identify a currently active application and treat this application as the target application matching with the keypress value.

As a possible implementation, before identifying a currently active application among the at least one application as a target application, the following operations may be performed:

activating an application with the highest priority among the at least one application when none of the at least one application is currently active.

Exemplarily, if at least two applications match with the keypress value and none of which is currently active, the terminal may select an application with the highest priority according to preset priorities of the at least two applications, and activate the application, and then this activated application is treated as the target application matching with the keypress value.

In this case, the priority is an importance priority or a time priority. As a possible implementation, the smaller the difference between the time that an user uses an application and the current time, the higher the time priority of the application.

For instance, the terminal may select an application with the highest priority, and activate the application and then the activated application is treated as the target application matching with the keypress value. In this instance, if the priority is an importance priority, the more important the application is, the higher the priority.

Some embodiments of the present application provide an implementation of keypress value information reported by an application, wherein the keypress value information reported by the application may include: correspondence between an application identity and a set of keypress values, wherein the set of keypress values refers to a set of all valid keypress values corresponding to the application identity, and the application identity include any one or more of an identifier (ID) of the application and a name of the application and the like.

Then, determining at least one application matching with the keypress value according to keypress value information reported by an application in running state, which includes:

acquiring at least one set of keypress values according to keypress value information reported by the application in running state, wherein each of the at least one set of keypress values comprises the keypress value;

determining at least one application identity corresponding to the at least one set of keypress values; and

determining at least one application matching with the keypress value according to the at least one application identity.

Exemplarily, the keypress value information reported by the application may include: correspondence between an application identity and a set of keypress values, wherein the set of keypress values refers to a set of all valid keypress values corresponding to the application identity. In other words, each application may correspond to a set of valid keypress values, and the set of valid keypress values may include all keypress values that are valid for the application. In this case, the application identity may include any one or more of: an identifier (ID) of the application, and a name of the application. All the keypress values in the set of keypress values are valid for the application. Further, the application identity may include type of the application.

Then, determining at least one application matching with the keypress value according to keypress value information reported by an application in running state, which may be implemented as follows:

first, searching at least one set of valid keypress values including the keypress value, then determining at least one application identity corresponding to the at least one set of valid keypress values, and finally determining at least one application matching with the keypress value according to the at least one application identity.

As a possible implementation, if the target application is a Web application, Step 103 may be realized as follows:

sending the keypress processing request to the Web application for processing via a browser corresponding to the Web application.

Exemplarily, if the target application matching with the keypress value is a Web application, then the terminal may send the keypress processing request to the Web application by the browser corresponding to the Web application.

In this case, it has been ensured that the keypress value is the one that the Web application is waiting for. The fact that the browser sends the keypress processing request to the Web application included therein guarantees correlation between the keypress and the Web application, and the keypress will not lost.

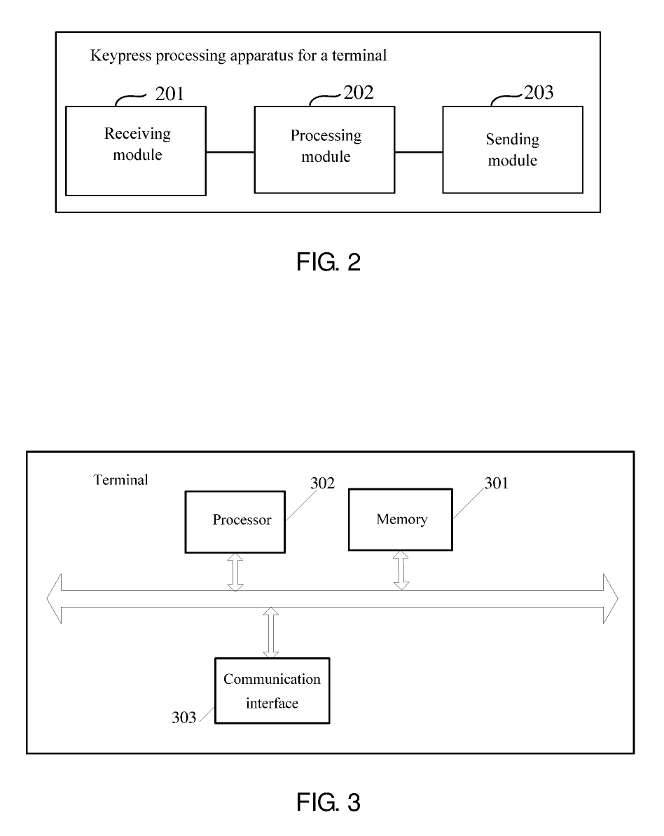

FIG. 2 is a schematic structural diagram of a keypress processing apparatus for a terminal provided in some embodiments of the present application. As depicted in FIG. 2, the apparatus includes:

a receiving module 201 for receiving a keypress processing request carrying a keypress value;

a processing module 202 for determining a target application matching with the keypress value carried in the keypress processing request, according to keypress value information reported by an application in running state in the terminal, wherein the target application includes a network Web application or a local application; and

a sending module 203 for sending the keypress processing request to the target application for processing.

As a possible implementation, the processing module 202 is configured to:

determine at least one application matching with the keypress value carried in the keypress processing request, according to keypress value information reported by an application in running state; and

identify a currently active application among the at least one application as the target application.

As a possible implementation, the processing module 202 may further be configured to:

If none of the at least one application matching with the keypress value is active, an application having the highest priority is activated according to preset priorities of the at least one application.

As a possible implementation, the keypress value information reported by the application may include: a set of all valid keypress values corresponding to application identity, where the application identity includes any one or more of: an ID of the application, and a name of the application.

The processing module 202 is configured to:

search a set of valid keypress values, to which the keypress value belongs, and determine identity information of at least one application matching with the set of valid keypress values; and

determine at least one application matching with the keypress value according to the identity information of the at least one application.

As a possible implementation, if the target application is a Web application, the sending module 203 is configured to:

send the keypress processing request to the Web application for processing via a browser corresponding to the Web application.

As a possible implementation, the processing module 202 is configured to:

activate the target application if the target application is running in a background.

The apparatus of embodiment of the present application may used to perform the technical solutions of the embodiments of the method described above. Both performing principle and technical effects of the apparatus are similar to those of the method and thus will not be repeated here.

The present application further provides a keypress processing apparatus for a terminal, including: a memory for storing instructions; a processor coupled with the memory and configured to execute the instructions stored in the memory, wherein the processor is further configured to:

receive a keypress processing request carrying a keypress value; determine a target application matching with the keypress value according to keypress value information reported by an application in running state in the terminal, wherein the application includes a network Web application or a local application, and the keypress value information includes a set of keypress values supported by the application; and send the keypress processing request to the target application for processing.

The processor in the keypress processing apparatus for a terminal provided in embodiments of the present application may further be configured to perform any one of the keypress processing methods for a terminal provided in the foregoing embodiments of the present application in a similar implementation principle, which will not be repeated here.

FIG. 3 is a schematic structural diagram of a terminal provided in some embodiments of the present application. As depicted FIG. 3, the terminal may include: a memory 301; a processor 302; and a communication interface 303, wherein the memory 301 is configured to store a program and the program, for example, may include a program code including a computer operation instruction. The memory 301 may include a random access memory (RAM), or a non-volatile memory, such as at least one disk storage.

The processor 302 is configured to perform the program stored in the memory 301 so as to carry out the technical solutions provided in embodiments of the present application. Both performing principal and technical effects of the processor are similar to those of the method described above and can refer to embodiments of the method, and thus will not be repeated here.

The communication interface 303 is configured to receive the keypress processing request.

Functions of the processing module and the sending module in the above described apparatus may be realized through the processor 302.

The aforementioned components communicate with each other via one or more buses. Those skilled in the art will appreciate that the structure for the terminal shown in FIG. 3 does not constitute a limit on the present application. The structure may be a bus-like structure or a star-shaped structure, and may include more or less components than shown in the figure, or some components may be combined, or arranged in an alternative way.

It should be noted that, since the terminal embodiments substantially correspond to the method embodiments, relevant parts of the terminal embodiments may refer to the method embodiments.

It will be appreciated by those skilled in the art that all or part of the steps of implementing the method embodiments described above may be accomplished by hardware related to program instructions and the program may be stored in a computer readable storage medium, and when the program is executed, the steps including the steps of the above method embodiments will be performed; and the foregoing storage medium includes various kinds of media that may store program codes, such as a ROM, a RAM, a magnetic disk, or an optical disk.

Finally, it should be noted that the above embodiments are merely illustrative of the technical solutions of the present application and are not intended to limit these technical solutions; while the present application has been described in detail with reference to the foregoing embodiments, it will be understood by those skilled in the art that, the technical solutions described in the foregoing embodiments can be modified, or some or all of the technical features therein can be equivalently replaced; and these modifications and replacements do not cause the essence of the corresponding technical solutions to depart from scope of the technical solutions of embodiments of the present application.

What is claimed is:

1. A keypress processing method for a terminal, comprising:
receiving a keypress processing request carrying a keypress value;
determining a target application matching with the keypress value according to keypress value information reported by an application in running state in the terminal, wherein the application comprises a network Web application or a local application, and the keypress value information comprises a set of keypress values supported by the application; and
sending the keypress processing request to the target application for processing.

2. The method according to claim 1, wherein the receiving a keypress processing request carrying a keypress value comprises:
receiving, by a core user interface (UI) processing program, the keypress processing request carrying the keypress value, which is sent by an application Management (AM).

3. The method according to claim 2, wherein the determining a target application matching with the keypress value according to keypress value information reported by an application in running state in the terminal comprises:
determining, by the core UI processing program, the target application matching with the keypress value according to keypress value information reported by an application in running state in the terminal.

4. The method according to claim 2, wherein the sending the keypress processing request to the target application for processing comprises:
sending, by the core UI processing program, the keypress processing request to the target application for processing.

5. The method according to claim 1, wherein before the sending the keypress processing request to the target application for processing, the method further comprises:
activating the target application if the target application is running in a background.

6. The method according to claim 3, wherein the determining a target application matching with the keypress value according to keypress value information reported by an application in running state in the terminal comprises:
determining at least one application matching with the keypress value according to keypress value information reported by an application in running state; and
identifying a currently active application among the at least one application as the target application.

7. The method according to claim 6, wherein before the identifying a currently active application among the at least one application as the target application, the method further comprises:
activating an application with the highest priority among the at least one application when none of the at least one application is currently active.

8. The method according to claim 6, wherein the keypress value information comprises:
correspondence between an application identity and the set of keypress values;
the determining at least one application matching with the keypress value according to keypress value information reported by an application in running state comprises:
acquiring at least one set of keypress values according to keypress value information reported by the application in running state, wherein each of the at least one set of keypress values comprises the keypress value;
determining at least one application identity corresponding to the at least one set of keypress values; and
determining at least one application matching with the keypress value according to the at least one application identity.

9. The method according to claim 8, wherein the application identity comprises any one or more of: an identifier (ID) of the application; and a name of the application.

10. The method according to claim 3, wherein before the determining a target application matching with the keypress value according to keypress value information reported by an application in running state in the terminal, the method further comprises:
receiving the keypress value information reported by the applications in running state in the terminal.

11. A keypress processing apparatus for a terminal, comprising: a memory for storing instructions; a processor coupled with the memory and configured to execute the instructions stored in the memory, wherein the processor is further configured to:
receive a keypress processing request carrying a keypress value;
determine a target application matching with the keypress value according to keypress value information reported by an application in running state in the terminal, wherein the application comprises a network Web application or a local application, and the keypress value information comprises a set of keypress values supported by the application; and
send the keypress processing request to the target application for processing.

12. The apparatus according to claim 11, wherein the processor is configured to:
receive, by a core user interface (UI) processing program, the keypress processing request carrying the keypress value, which is sent by an application Management (AM).

13. The apparatus according to claim 12, wherein the processor is configured to:
determine, by the core UI processing program, the target application matching with the keypress value according to keypress value information reported by an application in running state in the terminal.

14. The apparatus according to claim 12, wherein the processor is configured to:
send, by the core UI processing program, the keypress processing request to the target application for processing.

15. The apparatus according to claim 11, wherein the processor is further configured to:
activate the target application if the target application is running in a background.

16. The apparatus according to claim 13, wherein the processor is configured to:
determine at least one application matching with the keypress value according to keypress value information reported by an application in running state; and
identify a currently active application among the at least one application as the target application.

17. The apparatus according to claim 16, wherein the processor is further configured to:
activate an application with the highest priority among the at least one application when none of the at least one application is currently active.

18. The apparatus according to claim 16, wherein the keypress value information comprises: correspondence between an application identity and the set of keypress values; and
the processor is configured to:
acquire at least one set of keypress values according to keypress value information reported by the applications in running state, wherein each of the at least one set of keypress values comprises the keypress value;
determine at least one application identity corresponding to the at least one set of keypress values; and
determine at least one application matching with the keypress value according to the at least one application identity.

19. The apparatus according to claim 18, wherein the application identity comprises any one or more of: an identifier (ID) of the application, and a name of the application.

20. The apparatus according to claim 13, wherein the processor is further configured to:
receive the keypress value information reported by the applications in running state in the terminal.
